(19) United States
(12) Patent Application Publication
(10) Pub. No.: US 2025/0030022 A1
(43) Pub. Date: Jan. 23, 2025

(54) ELASTICALLY DEFORMABLE FLOW FIELD COMPONENT

(71) Applicant: HYAXIOM, INC., East Hartford, CT (US)

(72) Inventor: Jesse Marzullo, New Paltz, NY (US)

(21) Appl. No.: 18/354,927

(22) Filed: Jul. 19, 2023

(51) Int. Cl. H01M 8/04746; H01M 8/0232; H01M 8/1004

(52) U.S. Cl. CPC H01M 8/04746; H01M 8/0232; H01M 8/1004

(57) ABSTRACT

An illustrative example embodiment of a flow field component includes a plate having a first side and an oppositely facing second side. The plate has an undulating profile defining a plurality of segments and a plurality of channels between the segments on at least the first side of the plate. The undulating profile includes some of the segments in a first reference plane and others of the segments in a second reference plane that is parallel to and spaced from the first reference plane.

### BACKGROUND

Polymer electrolyte membrane (PEM) electrolyzers typically include a membrane electrode assembly (MEA) having an anode on one side and a cathode on the other. During operation, high cross-pressure from the cathode introduces a compressive force on the MEA and anode components. It is necessary to compensate for that pressure while still being able to withstand the high electrical potential and the oxidative environment within an electrolyzer. It is also necessary to maintain electrical contact with the membrane electrode assembly and separator plate.

Previous approaches tend to introduce additional expense, do not provide for consistent electrical contact with the anode side of the assembly, or suffer from both of those shortcomings. Compressible expanded meshes or transport layers are sometimes included within the anode compartment. Once subjected to axial loading, they at least partially flatten and the plastic deformation results in a lost ability to maintain reliable electrical contact between adjacent layers of the assembly under a variety of conditions. Alternatives aimed at avoiding plastic deformation include relatively complex metal and rubber composite structures, but they are considered undesirably expensive.

### SUMMARY

An illustrative example embodiment of a flow field component includes a plate having a first side and an oppositely facing second side. The plate has an undulating profile defining a plurality of segments and a plurality of channels between the segments on at least the first side of the plate. The undulating profile includes some of the segments in a first reference plane and others of the segments in a second reference plane that is parallel to and spaced from the first reference plane.

In an embodiment having one or more features of the flow field component of the previous paragraph, some of the segments remain in the first reference plane and others of the segments remain in the second reference plane in a first condition wherein the plate is under a first compressive load, the others of the segments being at least partially in the first reference plane in a second condition wherein the plate is under a second compressive load that is greater than the first compressive load.

In an embodiment having one or more features of the flow field component of any of the previous paragraphs, all of the segments are in the first reference plane in the second condition.

In an embodiment having one or more features of the flow field component of any of the previous paragraphs, the first compressive load corresponds to zero compressive force, the second compressive load corresponds to at least one of a load associated with positioning the flow field component within an electrolysis assembly and a load associated with operation of the electrolysis assembly.

In an embodiment having one or more features of the flow field component of any of the previous paragraphs, the plate is elastically deformable such that the others of the segments are repeatedly moveable between the first reference plane and the second reference plane.

An embodiment having one or more features of the flow field component of any of the previous paragraphs includes a plurality of second segments and a plurality of second channels on a second side of the plate that is opposite from the first side, wherein at least some of the second segments are at least partially oriented at an oblique angle relative to the first reference plane.

In an embodiment having one or more features of the flow field component of any of the previous paragraphs, the at least some of the second segments move toward being parallel with the first reference plane when the plate is subjected to a compressive load.

In an embodiment having one or more features of the flow field component of any of the previous paragraphs, the plate comprises a single piece of titanium.

In an embodiment having one or more features of the flow field component of any of the previous paragraphs, the plate comprises a single piece of stainless steel.

In an embodiment having one or more features of the flow field component of any of the previous paragraphs, the plate is stamped into a shape establishing the undulating profile with the segments in the respective reference planes.

An illustrative example embodiment of a method of making a flow field component includes stamping a plate to establish an undulating profile defining a plurality of segments and a plurality of channels between the segments on at least one side of the plate, the undulating profile including some of the segments in a first reference plane and others of the segments in a second reference plane that is parallel to and spaced from the first reference plane.

Another aspect includes a flow field component made according to the method of the previous paragraph.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates a selected portion of an example electrolyzer assembly including a flow field component designed according to an example embodiment.

FIG. 2 is a perspective, diagrammatic illustration of an example flowfield component designed according to an example embodiment.

FIG. 3 illustrates selected features of the example embodiment in a first condition.

FIG. 4 schematically illustrates installing the example embodiment in an electrolysis assembly.

FIG. 5 illustrates the example embodiment in a second condition.

### DETAILED DESCRIPTION

Embodiments of this invention include a stamped sheet flowfield that provides flow channels for an electrolysis assembly or a fuel cell. The stamped sheet is elastically deformable to respond to compressive loads without experiencing plastic deformation or crush. These features provide an economical component to facilitate fluid flow and maintain electrically conductive contact with adjacent components.

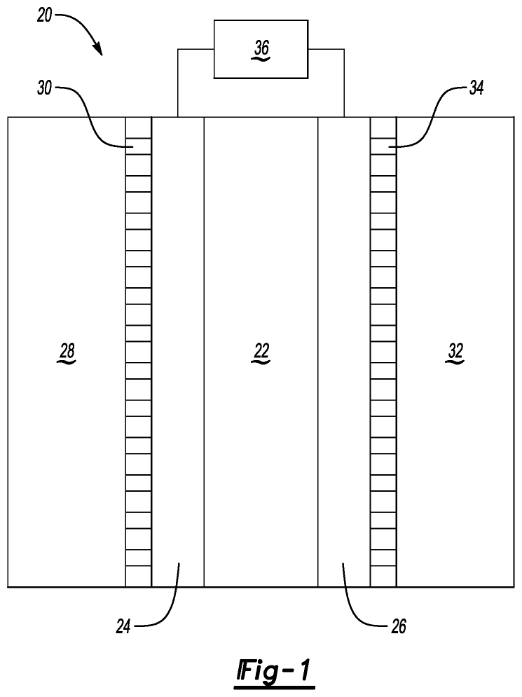

FIG. 1 schematically illustrates an electrolyzer assembly 20. A polymer electrolyte membrane (PEM) 22 is situated between catalyst layers 24 and 26. An anode portion 28 includes a flowfield component 30. A cathode portion 32 includes a flowfield component 34. A power source 36 supplies current to facilitate an electrolysis reaction for producing hydrogen, for example.

FIG. 2 shows an example configuration of the flowfield 30 on the anode side. The flowfield 30 comprises a single sheet 40 of material, such as a titanium or stainless steel, that is stamped into the illustrated configuration. The plate 40 has an undulating profile between a first edge 42 and second edge 44. A first side 46 of the plate 40 faces in a first direction (downward according to the drawing). A second side 48 faces in an opposite direction from the first side 46.

The undulating profile defines a plurality of segments 50 on the first side 46 of the plate 40. A plurality of channels 52 are established between adjacent segments 50. The undulating profile also defines a plurality of segments 60 on the second side 48 of the plate 40. A plurality of channels 62 are defined between the segments 60. The channels 52 and 62 are configured to facilitate fluid flow during operation of the electrolyzer 20. The segments 50 and 60 are configured to be received against adjacent electrolyzer components to establish electrically conductive contact with those components.

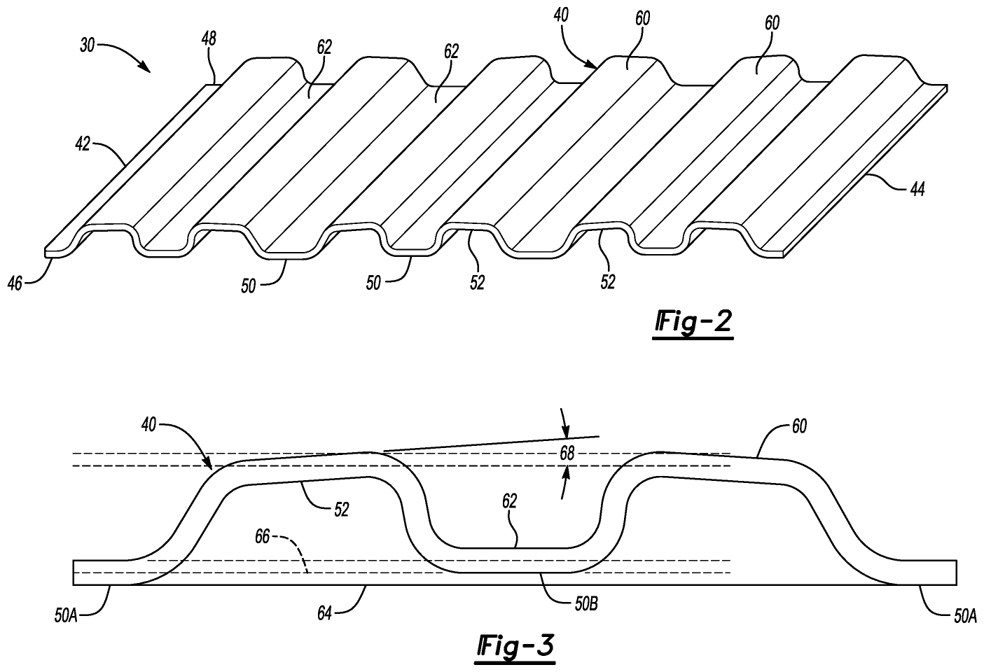

FIG. 3 illustrates relative positions of the segments 50 when the plate 40 is in a first condition. In this example, the first condition is a manufactured or stamped condition that may be considered an initial or rest condition of the plate 40. In the first condition, some of the segments 50A are situated in a first reference plane 64. Others of the segments 50B are situated in a second reference plane 66 that is generally parallel to and spaced from the first reference plane 64. Only one of the segments 50B is illustrated in FIGS. 3-5 for discussion purposes.

At least some of the segments 60 are oriented at an oblique angle shown at 68 relative to the first reference plane 64. That orientation of the segments 60 positions the segments 50B in the second reference plane 66 instead of the first reference plane 64 and provides a resilience to the plate 40 for responding to compressive loads exerted on the flowfield 30 when it is situated within an electrolyzer 20.

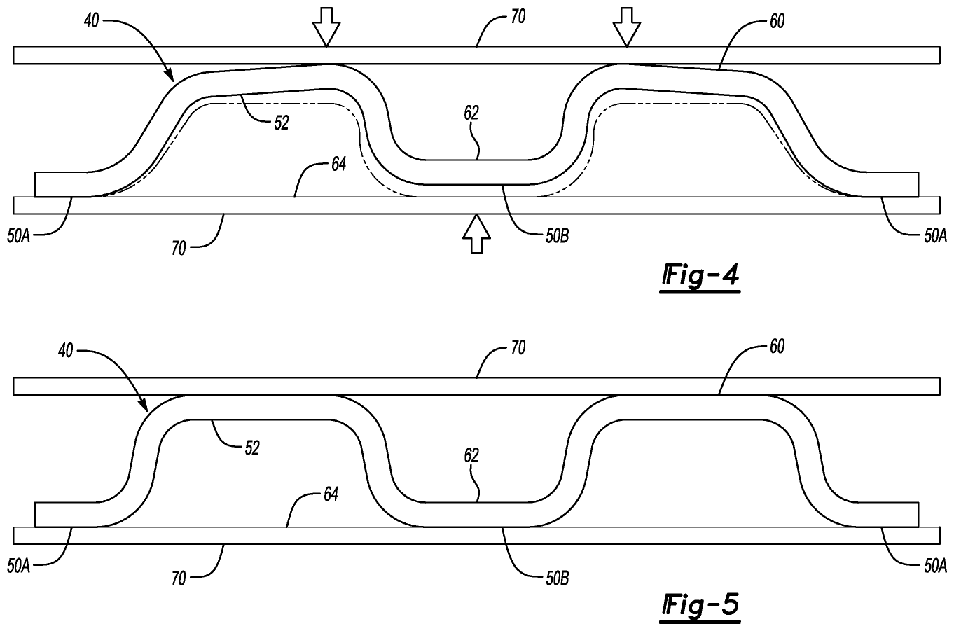

FIG. 4 schematically illustrates a process of installing the plate 40 within an electrolyzer between components schematically shown at 70. During assembly, the components 70 are urged toward each other exerting a compressive load on the plate 40, which is schematically represented by the arrows. As the components 70 are urged closer together, the segments 60 deflect and the segment 50B moves from the position shown in FIGS. 3 and 4 into the position shown in FIG. 5. Under compressive load, the segment 50B is at least partially within the first reference plane 64 along with the segments 50A. Corresponding portions of the plate 40 flex or bend under the compressive load to absorb the pressure exerted on the plate 40 during the assembly process.

Once the components 70 are in a properly assembled position relative to each other, the segments 60 and 50A, 50B all directly contact the component 70 immediately adjacent the respective segment. The plate 40, therefore, establishes electrically conductive contact between the components 70. The channels 52 and 62 allow for fluid to flow during operation of the electrolyzer 20.

In some embodiments, part of the process of installing the plate 40 in the electrolyzer 20 includes welding the edges 42 and 44 to the adjacent component 70 to secure the edges in a desired position. With the edges 42 and 44 secured, the plate 40 flexes or bends in response to the compressive load without the edges moving laterally outward.

Pressure within the cathode side 32 increases during electrolysis. The shape of the undulating profile of the plate 40 withstands such cross-pressure. In some embodiments, a minor amount of additional flexing occurs along the curved transitions of the undulating profile in response to the cross-pressure. This allows for some compressibility on the anode side after installation to withstand the pressures exerted from the cathode side while providing adequate support for the membrane electrode assembly.

The flowfield component 30 elastically deforms under the axial load. Elastic deformation is better than plastic deformation because the ability to resiliently return to its initial condition or orientation ensures that electrically conductive contact pressure may be maintained under all conditions within the electrolyzer 20. The example configuration with an undulating profile requires relatively little pressure for initially deflecting the plate 40 to move the segments 50A into the first reference plane 64. The undulating profile includes inflection points where considerably higher pressures are required to deflect the material of the plate 40 any further. The unique configuration of the plate 40 avoids exerting force on the membrane electrode assembly under low cross-pressure conditions while accomplishing an appropriate seal and maintaining electrically conductive contact with the adjacent components 70. During operation of the electrolyzer 20, when the cross-pressure from the cathode is high, the plate 40 allows for some additional compressibility but maintains good membrane mechanical support and continues to establish electrically conductive contact even after the cross-pressure reduces.

The compressive loads required to establish the initial contact deflection depend upon the bend radii at the transitions between the segments 50 and the channels 52 (and between the segments 60 and the channels 62). The draft angles, surface angle and material thickness also have an effect on the compressible load required for initial contact. Those same features of the plate 40 provide the structural stability that maintains good support for the membrane under the cross-pressure conditions. Given this description, those skilled in the art will be able to select appropriate values for the radii, angles and material thickness to achieve a flowfield configuration that meets their particular needs.

The stamped, single sheet plate, the undulating profile, and the elastic deformability of the example embodiment provides an economical and reliable flowfield component 30 for an electrolyzer. The flowfield component 30 may also be used in a fuel cell.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A flow field component, comprising a plate having a first side and an oppositely facing second side, the plate having an undulating profile defining a plurality of segments and a plurality of channels between the segments on at least the first side of the plate, the undulating profile including some of the segments in a first reference plane and others of the segments in a second reference plane that is parallel to and spaced from the first reference plane.

2. The flow field component of claim 1, wherein the some of the segments remain in the first reference plane and the others of the segments remain in the second reference plane in a first condition wherein the plate is under a first compressive load, the others of the segments being at least partially in the first reference plane in a second condition wherein the plate is under a second compressive load that is greater than the first compressive load.

3. The flow field component of claim 2, wherein all of the segments are in the first reference plane in the second condition.

4. The flow field component of claim 3, wherein the first compressive load corresponds to zero compressive force, the second compressive load corresponds to at least one of a load associated with positioning the flow field component within an electrolysis assembly and a load associated with operation of the electrolysis assembly.

5. The flow field component of claim 1, wherein the plate is elastically deformable such that the others of the segments are repeatedly moveable between the first reference plane and the second reference plane.

6. The flow field component of claim 1, including a plurality of second segments and a plurality of second channels on a second side of the plate that is opposite from the first side, wherein at least some of the second segments are at least partially oriented at an oblique angle relative to the first reference plane.

7. The flow field component of claim 6, wherein the at least some of the second segments move toward being parallel with the first reference plane when the plate is subjected to a compressive load.

8. The flow field component of claim 1, wherein the plate comprises a single piece of titanium.

9. The flow field component of claim 1, wherein the plate comprises a single piece of stainless steel.

10. The flow field component of claim 1, wherein the plate is stamped into a shape establishing the undulating profile with the segments in the respective reference planes.

11. A method of making a flow field component, the method comprising stamping a plate to establish an undulating profile defining a plurality of segments and a plurality of channels between the segments on at least one side of the plate, the undulating profile including some of the segments in a first reference plane and others of the segments in a second reference plane that is parallel to and spaced from the first reference plane.

12. A flow field component made according to the method of claim 11.
